(19) United States
(12) Patent Application Publication
(10) Pub. No.: US 2018/0203507 A1
(43) Pub. Date: Jul. 19, 2018

(54) WEARABLE DEVICE LOCKING AND UNLOCKING USING MOTION AND GAZE DETECTION

(71) Applicants: Yuchan HE, Yu Hang District, Hangzhou (CN); Alibaba Group Holding Limited, Grand Cayman (KY)

(72) Inventor: Yuchan HE, Hangzhou (CN)

(21) Appl. No.: 15/742,841

(22) PCT Filed: Jun. 28, 2016
(86) PCT No.: PCT/CN2016/087460

§ 371 Date: Jan. 8, 2018

(30) Foreign Application Priority Data
Jul. 8, 2015 (CN) 201510395695.2

(51) Int. Cl. G06F 3/01

(52) U.S. Cl. CPC G06F 3/013; G06K 9/00335

(57) ABSTRACT

The disclosed embodiments provide a screen processing method and apparatus. A method comprises: monitoring whether a user performs an action of using a wearable device; determining whether the user is visually focusing on a screen of the wearable device; and adjusting the screen of the wearable device if the user performs the action of using the wearable device and is visually focusing on the screen of the wearable device. The disclosed embodiments combine a user action with a visual focus, and adjust the screen only when two conditions are met, thus improving the screen adjustment accuracy and reducing the likelihood of an unwanted adjustment.

### CROSS-REFERENCE TO RELATED APPLICATIONS

This application claims the benefit of priority of Chinese Application No. 201510395695.2, titled “Screen Processing Method and Apparatus,” filed on Jul. 8, 2015 and PCT Application No. PCT/CN2016/087460, titled “Screen Processing Method and Apparatus,” filed on Jun. 28, 2016 which is hereby incorporated by reference in its entirety.

### BACKGROUND

### Technical Field

The disclosed embodiments relate to the field of electronic screen technologies, and in particular, to a screen processing method and apparatus.

### Description of the Related Art

A wearable device comprises a portable device, such as a mobile phone or an electronic wristwatch, that can be worn directly on the body of a user or integrated into a garment, or accessory, of a user. The wearable device is not only a hardware device, but may provide significant functionality via supporting software, data interactions, and cloud interactions.

The screen of a wearable device is generally where functionality is implemented. In the process of using a wearable device, a user generally needs to adjust the state of the wearable device screen (e.g., activating or turning off the screen). The conventional method for adjusting a wearable device is touch control. That is, the screen state may be adjusted by touching a button displayed on the wearable device. Such an operation may be simple, but this operation can cause certain difficulties for the user in particular contexts. For example, the user may not be able to finish an operation (e.g., activating or turning off the screen) when the user is exercising or his or her hands are not free.

To solve the above problems, current systems describe a gesture adjusting method where a screen is adjusted using a particular gesture or a common action of a user. Compared with existing methods, this method is relatively flexible and convenient. Yet, this method also suffers from various deficiencies. For example, an undesired operation is quite easily triggered as the user may be performing a similar action other than the specific gesture. The screen of the wearable device would then be inadvertently adjusted frequently due to the mistake.

### BRIEF SUMMARY

The disclosed embodiments provide a screen processing method and apparatus, which are used for increasing the screen adjustment accuracy and reducing the likelihood of an unwanted adjustment.

One aspect of the disclosure provides a screen processing method, comprising: monitoring whether a user performs an action of using a wearable device; determining whether the user is visually focusing on a screen of the wearable device; and adjusting the screen when the user performs the action of using the wearable device and is visually focusing on the screen.

Another aspect of the disclosure provides a screen processing method, comprising: monitoring whether a user performs an action of stopping using a wearable device; determining whether the user is visually focusing on a screen of the wearable device; and adjusting the screen when the user performs the action of stopping using the wearable device and is not visually focusing on the screen.

Still another aspect of the disclosure provides a screen processing apparatus, comprising: a monitoring module, configured to monitor whether a user performs an action of using a wearable device; a determining module, configured to determine whether the user is visually focusing on a screen of the wearable device; and an adjusting module, configured to adjust the screen when the user performs the action of using the wearable device and is visually focusing on the screen.

Still another aspect of the disclosure provides a screen processing apparatus, comprising: a monitoring module, configured to monitor whether a user performs an action of stopping using a wearable device; a determining module, configured to determine whether the user is visually focusing on a screen of the wearable device; and an adjusting module, configured to adjust the screen when the user performs the action of stopping using the wearable device and is not visually focusing on the screen.

The disclosed embodiments first monitor whether a user performs an action of using a wearable device; determines whether the user is visually focusing on a screen of the wearable device; and adjusts the screen of the wearable device only when the user performs the action of using the wearable device and is visually focusing on the screen of the wearable device. The disclosed embodiments combine a user action with a visual focus, and adjust the screen only when these two conditions are met, thus improving the screen adjustment accuracy and reducing the likelihood of an unwanted adjustment.

### BRIEF DESCRIPTION OF THE DRAWINGS

In order to illustrate the technical solutions in the disclosed embodiments more clearly, the drawings which need to be used in the description of the embodiments or the prior art will be introduced briefly in what follows. The drawings described below are merely some embodiments, and those of ordinary skill in the art can obtain other drawings according to these drawings without making creative efforts.

FIG. 1 is a flow diagram of a screen processing method according to some embodiments of the disclosure.

FIG. 2 is a flow diagram of a screen processing method according to some embodiments of the disclosure.

FIG. 3 is a block diagram of a screen processing apparatus according to some embodiments of the disclosure.

FIG. 4 is a block diagram of a screen processing apparatus according to some embodiments of the disclosure.

FIG. 5 is a block diagram of a screen processing apparatus according to some embodiments of the disclosure.

FIG. 6 is a block diagram of a screen processing apparatus according to some embodiments of the disclosure.

### DETAILED DESCRIPTION

In order to make the purposes, technical schemes, and advantages of the embodiments clearer, the technical schemes in the embodiments will be clearly and fully described below with reference to the drawings in the embodiments. Apparently, the described embodiments are part of the disclosed embodiments, rather than all the embodiments. On the basis of the embodiments, all other embodiments obtained by those skilled in the art without making creative efforts fall within the protection scope of the disclosure.

In current systems, a user may perform some actions, which are similar to actions used by the user to adjust a screen. The similar actions may cause the screen to be adjusted, when the user does not wish to do so in reality. Therefore, a problem of unwanted adjustments arises. The disclosed embodiments provide a solution to solve the problem that the screen is adjusted by mistake. At a high level, the disclosed embodiments combine a user action and a visual focus such that a screen of a wearable device is adjusted only when a user performs an action of using the wearable device and is visually focusing on the screen. Otherwise, the screen is kept in an initial state. The screen can be adjusted only when two conditions are met, thus improving the screen adjustment accuracy and reducing the likelihood of an unwanted adjustment.

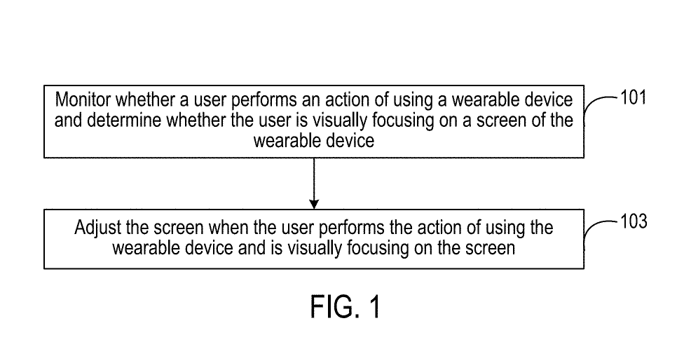

FIG. 1 is a flow diagram of a screen processing method according to some embodiments of the disclosure. As shown in FIG. 1, the method includes the following steps.

101: Monitor whether a user performs an action of using a wearable device and determine whether the user is visually focusing on a screen of the wearable device.

103: Adjust the screen if the user performs the action of using the wearable device and is visually focusing on the screen.

This embodiment provides a screen processing method with the purpose of adjusting a screen of a wearable device. The method may be executed by a screen processing apparatus. The screen processing apparatus may be implemented as a module in the wearable device, or may be independent of the wearable device but can communicate with the wearable device.

In this embodiment, the wearable device may be a portable device that can be directly worn on the body of a user, such as a smart wristwatch and a wristband. Alternatively, the wearable device may also be a portable device integrated into a garment or an accessory of a user, such as a mobile phone, an MP3, or a tablet computer.

During actual application, when a user needs to use a wearable device, the user generally performs an action of using the wearable device, such that the wearable device is at a position convenient for use. For example, for a smart wristwatch, the user may move his or her arm so that the screen of the smart wristwatch is moved to the height and at the direction suitable for the user to view. Further, the user may also perform an action such as turning or lowering his or her head correspondingly. For a mobile phone, the user may take the mobile phone out of his or her pocket or handbag and lift the mobile phone to the height and at the direction suitable for the user to view. Further, the user may also perform an action such as turning or lowering his or her head correspondingly.

Based on the above, the screen processing apparatus may monitor whether the user performs an action of using the wearable device, to predict whether the user needs to use the wearable device, thereby obtaining a reference for determining whether to adjust the screen of the wearable device. If it is monitored that the user performs the action of using the wearable device, it is determined that the user needs to use the wearable device; and it may be primarily determined that the screen of the wearable device needs to be adjusted. If it is not monitored that the user performs the action of using the wearable device, it is determined that the user does not need to use the wearable device; and it may be directly determined that the screen of the wearable device does not need to be adjusted.

The action performed by the user to use the wearable device may be embodied in a moving trace of the wearable device. Based on this, a trace range may be preset. The trace range may be obtained by the wearable device according to a moving trace embodied in a regular or habitual action performed by the user when using the wearable device. Based on this, the screen processing apparatus may monitor whether a moving trace of the wearable device in space falls within a preset range of traces. It is determined that the user performs the action of using the wearable device if it is monitored that the moving trace of the wearable device in space falls within the preset range of traces; and it is determined that the user does not perform the action of using the wearable device if it is monitored that the moving trace of the wearable device in space does not fall within the preset range of traces.

Specifically, the screen processing apparatus may monitor the moving trace of the wearable device by using various built-in sensors of the wearable device, such as a velocity sensor, a gyroscope, a magnetic sensor, or a displacement sensor.

It should be noted that actions performed by the user when using different wearable devices may be different, i.e., the moving traces of the wearable devices may be different. Therefore, methods of determining whether the moving trace of the wearable device falls within the preset range of traces may also be different.

In an alternative embodiment, the screen processing apparatus monitoring whether the moving trace of the wearable device falls within the preset range of traces comprises monitoring whether an angle change between a plane where the screen of the wearable device is located and the direction of gravity meets a preset angle change condition; and determining that the moving trace of the wearable device is monitored as falling within the preset range of traces when it is monitored that the angle change meets the preset angle change condition. Such a monitoring method is applicable to the screen of a wearable device when the device needs to be rotated when in use, such as a smart wristwatch and a smart wristband.

Specifically, by taking a wearable device worn on the wrist of a user such as a smart wristwatch or a smart wristband as an example, the preset angle change condition includes a direction of the angle change and a magnitude of the angle change. The direction of the angle change may be classified into a clockwise direction and a counterclockwise direction, and may be specifically set according to actual application situations. The magnitude of the angle change may be determined by using a preset angle threshold. If the wearable device is worn on the left hand of the user, it can be known according to a using habit of the user that a moving trace of the wearable device is upward and will rotate clockwise when the user uses the wearable device. Based on this, the screen processing apparatus may determine whether the direction of the angle change between the plane where the screen of the wearable device is located and the direction of gravity is clockwise and whether the magnitude of the angle change is greater than a preset first angle threshold. The angle change is monitored and determined to meet the preset angle change condition if the determining result is positive. In addition, if the wearable device is worn on the right hand of the user, it can be known according to the using habit of the user that a moving trace of the wearable device is upward and will rotate anticlockwise when the user uses the wearable device. Based on this, the screen processing apparatus may determine whether the direction of the angle change between the plane where the screen of the wearable device is located and the direction of gravity is anticlockwise and whether the magnitude of the angle change is greater than a preset second angle threshold. The angle change is monitored and determined to meet the preset angle change condition if the determining result is positive.

In determining whether the magnitude of the angle change is greater than the preset first angle threshold, the first angle threshold may be, but is not limited to, 60 degrees. Correspondingly, in the determining whether the magnitude of the angle change is greater than the preset second angle threshold, the second angle threshold may be 60 degrees. The first angle threshold and the second angle threshold may be the same or different.

In alternative embodiment, the screen processing apparatus monitoring whether the moving trace of the wearable device falls within the preset range of traces comprises monitoring acceleration magnitudes and magnitudes of angular velocity of the wearable device in X-axis, Y-axis, and Z-axis directions within a designated time; determining a moving trace of the wearable device according to the acceleration magnitudes and the magnitudes of angular velocity of the wearable device in the X-axis, Y-axis, and Z-axis directions; and then determining whether the moving trace falls within the preset range of traces.

In this embodiment, in addition to monitoring whether a user performs an action of using a wearable device, it is further necessary to determine whether the user is visually focusing on a screen of the wearable device, to determine whether to adjust the screen of the wearable device by combining the user action with the visual focus. In this embodiment, it is unnecessary to limit the order of executing the two operations of monitoring whether a user performs an action of using a wearable device and determining whether the user is visually focusing on a screen of the wearable device. Preferably, the monitoring whether a user performs an action of using a wearable device is executed first; and then it is determined whether the user is visually focusing on a screen of the wearable device after it is monitored that the user performs the action of using the wearable device. In this way, if it is monitored that the user does not perform the action of using the wearable device, the subsequent operation of determining whether the user is visually focusing on the screen of the wearable device may not be executed, thus saving resources.

In an alternative embodiment, the method of determining whether the user is visually focusing on the screen of the wearable device comprises carrying out a gaze-tracking process on the user to obtain a gaze point of the user; determining that the user is visually focusing on the screen if the gaze point of the user is located on the screen; and determining that the user is not visually focusing on the screen if the gaze point of the user is not located on the screen; and

One embodiment of carrying out a gaze-tracking process on the user to obtain a gaze point of the user comprises starting a camera on the wearable device; recording an eye movement of the user for a designated time length by using the camera to obtain an eye movement video; and carrying out an image analysis on the eye movement video to obtain the gaze point of the user.

In recording an eye movement of the user for a designated time length by using the camera, the designated time length is not limited and may be adaptively set according to different wearable devices. The designated time length may be, but is not limited to, 2 seconds.

It should be noted that the adjustment on the screen of the wearable device in this embodiment includes activating the screen or adjusting the screen brightness. Generally, the adjustment may comprise decreasing the screen brightness.

Optionally, the screen is kept in an initial state if the user does not perform the action of using the wearable device or the user is not visually focusing on the screen. The initial state here may be a dormancy state or a low brightness state. The low brightness refers to the status when the screen brightness is lower than a brightness threshold.

In view of the above, the screen processing method provided in this embodiment monitors whether a user performs an action of using a wearable device; determines whether the user is visually focusing on a screen of the wearable device; and adjusts the screen of the wearable device only when the user performs the action of using the wearable device and is visually focusing on the screen of the wearable device. It can be seen that this embodiment combines the user action with the visual focus, and adjusts the screen only when two conditions are met, thus improving the screen adjustment accuracy and reducing the likelihood of an unwanted adjustment. In addition, by using the method provided in this embodiment, the user can implement adjustment of the screen conveniently and accurately without any manual operation, thus bringing convenience for users when using the wearable device.

It should be noted that the methods described above can be used not only for activating a screen of a wearable device when the screen is in a dormancy state or increasing the screen brightness when the screen brightness is low. For example, the method may also be used for turning off the screen of the wearable device when the screen is in an activated state or reducing the screen brightness when the screen brightness is high.

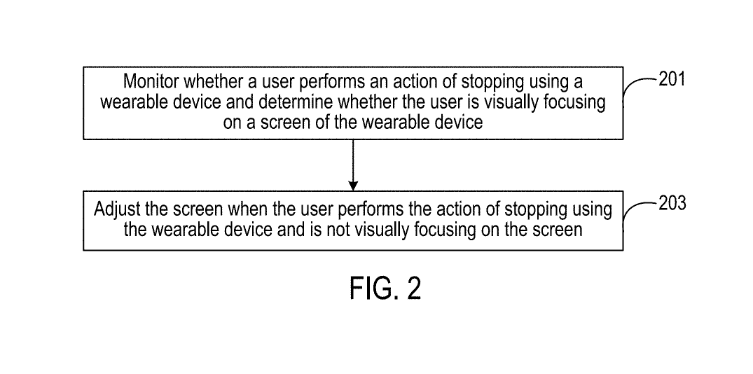

FIG. 2 is a flow diagram of a screen processing method according to some embodiments of the disclosure. As shown in FIG. 2, the method includes the following steps.

201: Monitor whether a user performs an action of stopping using a wearable device and determine whether the user is visually focusing on a screen of the wearable device.

203: Adjust the screen if the user performs the action of stopping using the wearable device and is not visually focusing on the screen.

This embodiment provides a screen processing method with the purpose of adjusting a screen of a wearable device. The method may be executed by a screen processing apparatus. The screen processing apparatus may be implemented as a module in the wearable device, or may be independent of the wearable device but can communicate with the wearable device.

In this embodiment, the wearable device may be a portable device that can be directly worn on the body of a user, such as a smart wristwatch and a wristband. Alternatively, the wearable device may also be a portable device integrated into a garment or an accessory of a user, such as a mobile phone, an MP3, or a tablet computer.

During actual application, when a user needs to use a wearable device, the user generally performs an action of using the wearable device, such that the wearable device is at a position convenient for use. For example, for a smart wristwatch, the user may move his or her arm so that the screen of the smart wristwatch is moved to the height and at the direction suitable for the user to view. Further, the user may also perform an action such as turning or lowering his or her head correspondingly. For a mobile phone, the user may take the mobile phone out of his or her pocket or handbag and lift the mobile phone to the height and at the direction suitable for the user to view. Further, the user may also perform an action such as turning or lowering his or her head correspondingly. Correspondingly, when stopping using the wearable device, the user will perform an action to stop using the wearable device, and the action may be an action opposite to the action of using the wearable device.

Based on the above, the screen processing apparatus may monitor whether the user performs an action of stopping using the wearable device, to predict whether the user needs to stop using the wearable device, thereby obtaining a reference for determining whether to adjust the screen of the wearable device. If it is monitored that the user performs the action of stopping using the wearable device, it is determined that the user needs to stop using the wearable device; and it may be primarily determined that the screen of the wearable device needs to be adjusted. If it is not monitored that the user performs the action of stopping using the wearable device, it is determined that the user needs to continue using the wearable device; and the screen of the wearable device may be continuously kept in its initial state.

The action performed by the user to stop using the wearable device may be embodied in the moving trace of the wearable device. Based on this, a trace range may be preset. The trace range may be obtained by the wearable device according to a moving trace embodied in a regular or habitual action performed by the user when stopping using the wearable device. Based on this, the screen processing apparatus may monitor whether a moving trace of the wearable device falls within a preset range of traces. It is determined that the user performs the action to stop using the wearable device if it is monitored that the moving trace of the wearable device falls within the preset range of traces. It is determined that the user does not perform the action of stopping using the wearable device if it is monitored that the moving trace of the wearable device does not fall within the preset range of traces. It should be noted that, the trace range here is the same as the trace range preset by the user when using the wearable device; the only difference is that the direction is opposite.

Specifically, the screen processing apparatus may monitor the moving trace of the wearable device by using various built-in sensors of the wearable device, such as a velocity sensor, a gyroscope, a magnetic sensor, or a displacement sensor.

It should be noted that actions performed by the user when stopping using different wearable devices may be different, i.e., the moving traces of the wearable devices may be different. Therefore, methods of determining whether the moving trace of the wearable device falls within the preset range of traces may also be different.

In an alternative embodiment, the screen processing apparatus monitoring whether the moving trace of the wearable device falls within the preset range of traces comprises monitoring whether an angle change between a plane where the screen of the wearable device is located and the direction of gravity meets a preset angle change condition; and determining that the moving trace of the wearable device is monitored as falling within the preset range of traces when it is monitored that the angle change meets the preset angle change condition. Such a monitoring method is applicable to the screen of a wearable device when the device needs to be rotated being stopped for using, such as a smart wristwatch and a smart wristband.

Specifically, by taking a wearable device worn on the wrist of a user such as a smart wristwatch or a smart wristband as an example, the preset angle change condition includes a direction of the angle change and a magnitude of the angle change. The direction of the angle change may be classified into a clockwise direction and a counterclockwise direction, and may be specifically set according to actual application situations. The magnitude of the angle change may be determined by using a preset angle threshold. Generally speaking, if the wearable device is worn on the left hand of the user, it can be known according to a using habit of the user that a moving trace of the wearable device is downward and will rotate counterclockwise when the user stops using the wearable device. Based on this, the screen processing apparatus may determine whether the direction of the angle change between the plane where the screen of the wearable device is located and the direction of gravity is counterclockwise and whether the magnitude of the angle change is greater than a preset first angle threshold. The angle change is monitored and determined to meet the preset angle change condition if the determining result is positive. In addition, if the wearable device is worn on the right hand of the user, it can be known according to the using habit of the user that the moving trace of the wearable device is downward and will rotate clockwise when the user stops using the wearable device. Based on this, the screen processing apparatus may determine whether the direction of the angle change between the plane where the screen of the wearable device is located and the direction of gravity is clockwise and whether the magnitude of the angle change is greater than a preset second angle threshold. The angle change is monitored and determined to meet the preset angle change condition if the determining result is positive.

In determining whether the magnitude of the angle change is greater than the preset first angle threshold, the first angle threshold may be, but is not limited to, 60 degrees. Correspondingly, in the determining whether the magnitude of the angle change is greater than the preset second angle threshold, the second angle threshold may be 60 degrees. The first angle threshold and the second angle threshold may be the same or different.

In alternative embodiment, the screen processing apparatus monitoring whether the moving trace of the wearable device falls within the preset range of traces comprises monitoring acceleration magnitudes and magnitudes of angular velocity of the wearable device in X-axis, Y-axis, and Z-axis directions within a designated time; determining a moving trace of the wearable device according to the acceleration magnitudes and the magnitudes of angular velocity of the wearable device in the X-axis, Y-axis, and Z-axis directions; and then determining whether the moving trace falls within the preset range of traces.

In this embodiment, in addition to monitoring whether a user performs an action to stop using a wearable device, it is further necessary to determine whether the user is visually focusing on a screen of the wearable device, to determine whether to adjust the screen of the wearable device by combining the user action with the visual focus. In this embodiment, it is unnecessary to limit an order of executing the two operations of monitoring whether a user performs an action of stopping using a wearable device and determining whether the user is visually focusing on a screen of the wearable device. Preferably, the monitoring whether a user performs an action of stopping using a wearable device is executed first; and then it is determined whether the user is visually focusing on a screen of the wearable device after it is monitored that the user performs the action to stop using the wearable device. In this way, if it is monitored that the user does not perform the action of stopping using the wearable device, the subsequent operation of determining whether the user is visually focusing on the screen of the wearable device may not be executed, thus saving resources.

In an alternative embodiment, the method of determining whether the user is visually focusing on the screen of the wearable device comprises carrying out a gaze-tracking process on the user to obtain a gaze point of the user; determining that the user is visually focusing on the screen if the gaze point of the user is located on the screen; and determining that the user is not visually focusing on the screen if the gaze point of the user is not located on the screen; and

One embodiment of carrying out a gaze-tracking process on the user to obtain a gaze point of the user comprises starting a camera on the wearable device; recording an eye movement of the user for a designated time length by using the camera to obtain an eye movement video; and carrying out an image analysis on the eye movement video to obtain the gaze point of the user.

In the recording an eye movement of the user for a designated time length by using the camera, the designated time length is not limited and may be adaptively set according to different wearable devices. The designated time length may be, but is not limited to, 2 seconds.

It should be noted that the adjustment on the screen of the wearable device in this embodiment includes turning off the screen or adjusting the screen brightness. Generally, the adjustment may comprise decreasing the screen brightness.

Optionally, the screen is kept in an initial state if the user does not perform the action of stopping using the wearable device or the user is visually focusing on the screen. The initial state here may be an activated state or a high brightness state. The high brightness refers to the status when the screen brightness is higher than a brightness threshold.

In view of the above, the screen processing method provided in this embodiment monitors whether a user performs an action of stopping using a wearable device, determines whether the user is visually focusing on a screen of the wearable device; and adjusts the screen of the wearable device only when the user performs the action of stopping using the wearable device and is not visually focusing on the screen of the wearable device. It can be seen that this embodiment combines the user action with the visual focus, and adjusts the screen only when two conditions are met, thus improving the screen adjustment accuracy and reducing the likelihood of an unwanted adjustment. In addition, by using the method provided in this embodiment, the user can implement adjustment of the screen conveniently and accurately without any manual operation, thus bringing convenience for users when using the wearable device.

It should be noted that in order to briefly describe each foregoing method embodiment, all the method embodiments are expressed as a combination of a series of actions. Those skilled in the art should know that the disclosed embodiments are not limited by the sequence of the described actions. Certain steps can be applied with different sequences or can be carried out at the same time according to the disclosed embodiments. Secondly, those skilled in the art should also know that all the embodiments described in the description belong to exemplary embodiments and the related actions and modules are not necessarily needed for the disclosure.

In the embodiments, the description of each embodiment has its own focus; and references for those that are not described in detail in a certain embodiment can be made by referring to the related descriptions of other embodiments.

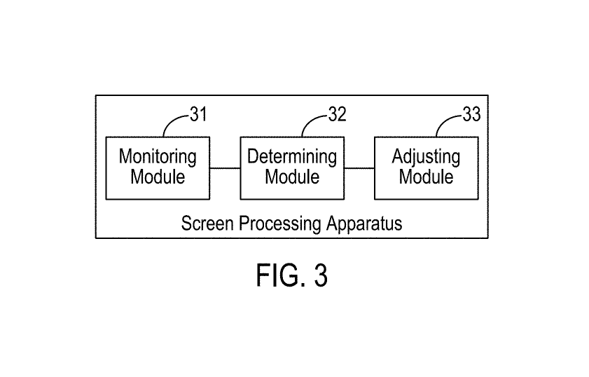

FIG. 3 is a block diagram of a screen processing apparatus according to some embodiments of the disclosure. As shown in FIG. 3, the apparatus includes: a monitoring module 31, a determining module 32, and an adjusting module 33.

The monitoring module 31 is configured to monitor whether a user performs an action of using a wearable device.

The determining module 32 is configured to determine whether the user is visually focusing on a screen of the wearable device.

The adjusting module 33 is configured to adjust the screen when the monitoring module 31 monitors that the user performs the action of using the wearable device and the determining module 32 determines that the user is visually focusing on the screen. The adjusting the screen here mainly refers to activating the screen, or adjusting the screen brightness; generally it is to increase the screen brightness.

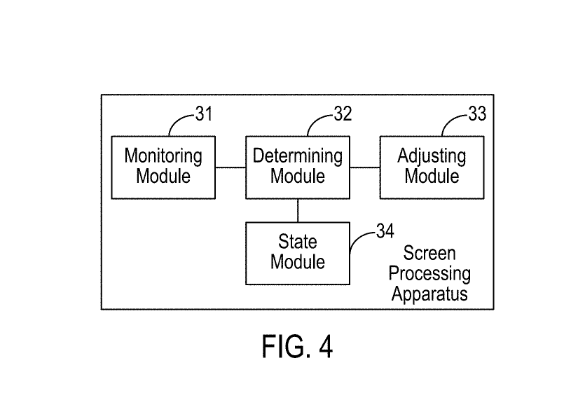

In an alternative embodiment, as shown in FIG. 4, the apparatus further includes a state module 34.

The state module 34 is configured to keep the screen in an initial state when the monitoring module 31 monitors that the user does not perform the action of using the wearable device or the determining module 32 determines that the user is not visually focusing on the screen. The initial state is a dormancy state or a low screen brightness state. The low brightness refers to the status when the screen brightness is lower than a brightness threshold.

In an alternative embodiment, the determining module 32 is configured to determine whether the user is visually focusing on the screen of the wearable device after the monitoring module 31 monitors that the user performs the action of using the wearable device.

In an alternative embodiment, the monitoring module 31 may specifically be configured to: monitor whether a moving trace of the wearable device in space falls within a preset range of traces; and determine that the user performs the action of using the wearable device if it is monitored that the moving trace of the wearable device in space falls within the preset range of traces.

In an alternative embodiment, when monitoring whether the moving trace of the wearable device falls within the preset range of traces, the monitoring module 31 is configured to: monitor whether an angle change between a plane where the screen is located and the direction of gravity meets a preset angle change condition; and determine that the moving trace of the wearable device is monitored as falling within the preset range of traces when it is monitored that the angle change meets the preset angle change condition.

In an alternative embodiment, when monitoring whether the angle change between the plane where the screen is located and the direction of gravity meets the preset angle change condition, the monitoring module 31 is configured to: determine whether the angle changes in a clockwise direction and whether a magnitude of the angle change is greater than a preset first angle threshold if the wearable device is worn on the left hand of the user; and determining that the angle change is monitored as meeting the preset angle change condition if the determining result is positive; and determine whether the angle changes in a counterclockwise direction and whether the magnitude of the angle change is greater than a preset second angle threshold if the wearable device is worn on the right hand of the user; and determining that the angle change is monitored as meeting the preset angle change condition if the determining result is positive.

In an alternative embodiment, the determining module 32 is configured to: carry out a gaze-tracking process on the user to obtain a gaze point of the user; determine that the user is visually focusing on the screen if the gaze point of the user is located on the screen; and determine that the user is not visually focusing on the screen if the gaze point of the user is not located on the screen.

Further, when carrying out the gaze-tracking process on the user to obtain the gaze point of the user, the determining module 32 is configured to: start a camera on the wearable device; record an eye movement of the user for a designated time length by using the camera to obtain an eye movement video; and carry out an image analysis on the eye movement video to obtain the gaze point of the user.

The screen processing apparatus provided in this embodiment monitors whether a user performs an action of using a wearable device; determines whether the user is visually focusing on a screen of the wearable device; and adjusts the screen of the wearable device only when it is monitored that the user performs the action of using the wearable device and the user is visually focusing on the screen of the wearable device. It can be seen that the screen processing apparatus provided in this embodiment combines the user action with the visual focus, and adjusts the screen only when two conditions are met, thus improving the screen adjustment accuracy and reducing the likelihood of an unwanted adjustment.

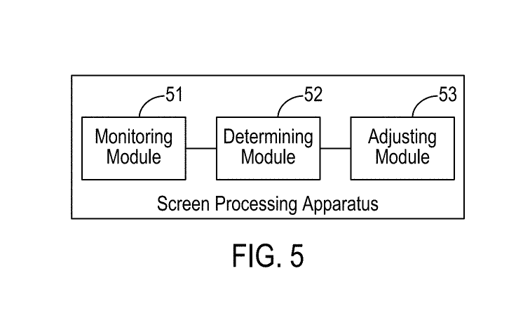

FIG. 5 is a block diagram of a screen processing apparatus according to some embodiments of the disclosure. As shown in FIG. 5, the apparatus includes: a monitoring module 51, a determining module 52, and an adjusting module 53.

The monitoring module 51 is configured to monitor whether a user performs an action of stopping using a wearable device.

The determining module 52 is configured to determine whether the user is visually focusing on a screen of the wearable device.

The adjusting module 53 is configured to adjust the screen when the monitoring module 51 monitors that the user performs the action of stopping using the wearable device and the determining module 52 determines that the user is not visually focusing on the screen. The adjusting the screen here mainly refers to turning off the screen, or adjusting the screen brightness; generally it is to reduce the screen brightness.

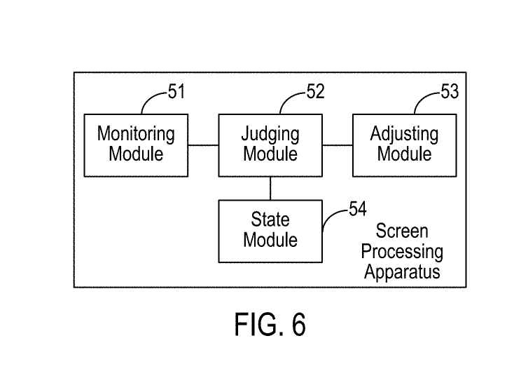

In an alternative embodiment, as shown in FIG. 6, the apparatus further includes a state module 54.

The state module 54 is configured to keep the screen in an initial state when the monitoring module 51 monitors that the user does not perform the action of stopping using the wearable device or the determining module 52 determines that the user is visually focusing on the screen. The initial state here may be an activated state or a high brightness state. The high brightness refers to the status when the screen brightness is higher than a brightness threshold.

In an alternative embodiment, the determining module 52 is configured to determine whether the user is visually focusing on the screen of the wearable device after the monitoring module 51 monitors that the user performs the action of stopping using the wearable device.

In an alternative embodiment, the monitoring module 51 may specifically be configured to: monitor whether a moving trace of the wearable device in space falls within a preset range of traces; and determine that the user performs the action of stopping using the wearable device if it is monitored that the moving trace of the wearable device in space falls within the preset range of traces.

Further, when monitoring whether the moving trace of the wearable device falls within the preset range of traces, the monitoring module 51 may specifically be configured to: monitor whether an angle change between a plane where the screen is located and the direction of gravity meets a preset angle change condition; and determine that the moving trace of the wearable device is monitored as falling within the preset range of traces when it is monitored that the angle change meets the preset angle change condition.

Further, when monitoring whether the angle change between the plane where the screen is located and the direction of gravity meets the preset angle change condition, the monitoring module 51 may specifically be configured to: determine whether the angle changes in a counterclockwise direction and whether a magnitude of the angle change is greater than a preset first angle threshold if the wearable device is worn on the left hand of the user; and determining that the angle change is monitored as meeting the preset angle change condition if the determining result is positive; and determine whether the angle changes in a clockwise direction and whether the magnitude of the angle change is greater than a preset second angle threshold if the wearable device is worn on the right hand of the user; and determining that the angle change is monitored as meeting the preset angle change condition if the determining result is positive.

In an alternative embodiment, the determining module 52 is configured to: carry out a gaze-tracking process on the user to obtain a gaze point of the user; determine that the user is visually focusing on the screen if the gaze point of the user is located on the screen; and determine that the user is not visually focusing on the screen if the gaze point of the user is not located on the screen.

Further, when carrying out the gaze-tracking process on the user to obtain the gaze point of the user, the determining module 52 is configured to: start a camera on the wearable device; record an eye movement of the user for a designated time length by using the camera to obtain an eye movement video; and carry out an image analysis on the eye movement video to obtain the gaze point of the user.

The screen processing apparatus provided in this embodiment monitors whether a user performs an action of stopping using a wearable device; determines whether the user is visually focusing on a screen of the wearable device; and adjusts the screen of the wearable device only when it is monitored that the user performs the action of stopping using the wearable device and the user is not visually focusing on the screen of the wearable device. It can be seen that the screen processing apparatus provided in this embodiment combines the user action with the visual focus, and adjusts the screen only when two conditions are met, thus improving the screen adjustment accuracy and reducing the likelihood of an unwanted adjustment. In addition, by using the method provided in this embodiment, the user can implement adjustment of the screen conveniently and accurately without any manual operation, thus bringing convenience for users when using the wearable device.

Those skilled in the art can clearly understand that for a convenient and concise description, references of the specific working processes of the systems, the apparatuses, and the units described above can be made by referring to the corresponding processes in the foregoing method embodiments; they are not repeated herein.

In the several embodiments provided by the disclosure, it should be understood that the disclosed systems, apparatuses, and methods can be implemented in other ways. For example, the device embodiment described above is merely exemplary. For example, the division of the units is merely a logical function division; other division methods in practical implementation may exist, like a plurality of units or components can be combined or can be integrated into another system; or some features can be ignored or are not executed. From another point, the intercoupling, direct coupling, or communication connection displayed or discussed may be electrical, mechanical or other forms through some interfaces, indirect coupling or communication connection of the device or the units.

The units described as separate parts may or may not be physically separated; and the parts shown as units may or may not be physical units, which may be located in one place or may be distributed onto a plurality of network units. The objective of the solution of this embodiment may be implemented by selecting a part of or all the units according to actual requirements.

In addition, various functional units in the embodiments may be integrated in one processing unit, or the units exist physically and separately, or two or more units are integrated in one unit. The integrated unit may be implemented by using hardware, and may be implemented in a form of hardware plus a software functional unit.

The integrated unit implemented in the form of a software functional unit may be stored in a computer readable storage medium. The software functional unit is stored in a storage medium, and includes several instructions that enable a computer device (which may be a personal computer, a server, a network device or the like) or a processor to execute partial steps of the method in the embodiments of the present application. The foregoing storage medium includes various media capable of storing program code, including a USB flash disk, a mobile hard disk, a Read-Only Memory (ROM), a Random Access Memory (RAM), a magnetic disk, an optical disc, or the like.

It should be finally noted that the above embodiments are merely used for illustrating rather than limiting the technical solutions of the disclosure. Although the disclosure is described in detail with reference to the foregoing embodiments, those of ordinary skill in the art should understand that the technical solutions recorded in the foregoing embodiments may still be modified or equivalent replacement may be made on partial technical features therein. These modifications or replacements will not make the essence of the corresponding technical solutions be departed from the spirit and scope of the technical solutions in the disclosed embodiments.

1-32. (canceled)

33. A method comprising:
monitoring, by a wearable device, whether a user performs an action using the wearable device, the action causing a movement of the wearable device;
determining, by the wearable device, that the user is visually focusing on a screen of the wearable device; and
adjusting, by the wearable device, the screen when the user performs the action using the wearable device and is visually focusing on the screen of the wearable device.

34. The method of claim 33, the determining that the user is visually focusing on a screen of the wearable device further comprising determining that the visual focus of the user is on the screen of the wearable device after monitoring that the user performs the action using the wearable device

35. The method of claim 33, further comprising keeping, by the wearable device, the screen in an initial state if the user does not perform the action using the wearable device or if the user is not visually focusing on the screen of the wearable device.

36. The method of claim 33, the monitoring whether a user performs an action using the wearable device further comprising:
monitoring, by the wearable device, whether a moving trace of the wearable device in space falls within a preset range of traces; and
determining, by the wearable device, that the user performs the action using the wearable device if the moving trace of the wearable device in space falls within the preset range of traces.

37. The method of claim 36, the monitoring whether a moving trace of the wearable device in space falls within a preset range of traces further comprising:
monitoring, by the wearable device, whether an angle change between a plane where the screen is located and a direction of gravity meets a preset angle change condition; and
determining, by the wearable device, that the moving trace of the wearable device in space is within the preset range of traces when the angle change meets the preset angle change condition.

38. The method of claim 37, the action using the wearable device comprising a stopping action.

39. The method of claim 38, the monitoring whether an angle change between a plane where the screen is located and a direction of gravity meets a preset angle change condition further comprising:
determining, by the wearable device, that the angle change meets the preset angle change condition if:
the wearable device is worn on the left hand of the user, the angle changes in a counterclockwise direction, and a magnitude of the angle change is greater than a preset first angle threshold, or
the wearable device is worn on the right hand of the user, the angle changes in a clockwise direction, and a magnitude of the angle change is greater than a preset second angle threshold.

40. The method of claim 36, the monitoring whether an angle change between a plane where the screen is located and a direction of gravity meets a preset angle change condition further comprising:
determining, by the wearable device, that the angle change meets the preset angle change condition if:
the wearable device is worn on the left hand of the user, the angle changes in a clockwise direction, and a magnitude of the angle change is greater than a preset first angle threshold, or
the wearable device is worn on the right hand of the user, the angle changes in a counterclockwise direction, and the magnitude of the angle change is greater than a preset second angle threshold.

41. The method of claim 33, the determining that the user is visually focusing on a screen of the wearable device further comprising:
executing, by the wearable device, a gaze-tracking process to obtain a gaze point of the user;
determining, by the wearable device, that the user is visually focusing on the screen if the gaze point of the user is located on the screen; and
determining, by the wearable device, that the user is not visually focusing on the screen if the gaze point of the user is not located on the screen

42. The method of claim 41, the executing out a gaze-tracking process to obtain a gaze point of the user further comprising:
starting, by the wearable device, a camera on the wearable device;
recording, via a camera on the wearable device, an eye movement video capturing an eye movement of the user for a designated time length; and
performing, by the wearable device, image analysis on the eye movement video to obtain the gaze point of the user.

43. A wearable device comprising:
a processor; and
a storage medium for tangibly storing thereon program logic for execution by the processor, the stored program logic comprising:
logic, executed by the processor, for monitoring whether a user performs an action using the wearable device, the action causing a movement of the wearable device;
logic, executed by the processor, for determining that the user is visually focusing on a screen of the wearable device; and
logic, executed by the processor, for adjusting the screen when the user performs the action using the wearable device and is visually focusing on the screen of the wearable device.

44. The wearable device of claim 43, further comprising logic, executed by the processor, for keeping the screen in an initial state if the user does not perform the action using the wearable device or if the user is not visually focusing on the screen of the wearable device.

45. The wearable device of claim 43, the logic for monitoring whether a user performs an action using the wearable device further comprising:
logic, executed by the processor, for monitoring whether a moving trace of the wearable device in space falls within a preset range of traces; and
logic, executed by the processor, for determining that the user performs the action using the wearable device if the moving trace of the wearable device in space falls within the preset range of traces.

46. The wearable device of claim 45, the logic for monitoring whether a moving trace of the wearable device in space falls within a preset range of traces further comprising:
logic, executed by the processor, for monitoring whether an angle change between a plane where the screen is located and a direction of gravity meets a preset angle change condition; and
logic, executed by the processor, for determining that the moving trace of the wearable device in space is within the preset range of traces when the angle change meets the preset angle change condition.

47. The wearable device of claim 46, the action using the wearable device comprising a stopping action.

48. The wearable device of claim 47, the logic for monitoring whether an angle change between a plane where the screen is located and a direction of gravity meets a preset angle change condition further comprising:
logic, executed by the processor, for determining that the angle change meets the preset angle change condition if:
the wearable device is worn on the left hand of the user, the angle changes in a counterclockwise direction, and a magnitude of the angle change is greater than a preset first angle threshold, or
the wearable device is worn on the right hand of the user, the angle changes in a clockwise direction, and a magnitude of the angle change is greater than a preset second angle threshold.

49. The wearable device of claim 45, the logic for monitoring whether an angle change between a plane where the screen is located and a direction of gravity meets a preset angle change condition further comprising:
logic, executed by the processor, for determining that the angle change meets the preset angle change condition if:
the wearable device is worn on the left hand of the user, the angle changes in a clockwise direction, and a magnitude of the angle change is greater than a preset first angle threshold, or
the wearable device is worn on the right hand of the user, the angle changes in a counterclockwise direction, and the magnitude of the angle change is greater than a preset second angle threshold.

50. The wearable device of claim 43, the logic for determining that the user is visually focusing on a screen of the wearable device further comprising:
logic, executed by the processor, for executing a gaze-tracking process to obtain a gaze point of the user;
logic, executed by the processor, for determining that the user is visually focusing on the screen if the gaze point of the user is located on the screen; and
logic, executed by the processor, for determining that the user is not visually focusing on the screen if the gaze point of the user is not located on the screen

51. The wearable device of claim 50, the logic for executing out a gaze-tracking process to obtain a gaze point of the user further comprising:
logic, executed by the processor, for starting a camera on the wearable device;
logic, executed by the processor, for recording, via a camera, an eye movement video capturing an eye movement of the user for a designated time length; and
logic, executed by the processor, for performing image analysis on the eye movement video to obtain the gaze point of the user.

52. A device comprising:
a processor;
a sensor communicatively coupled to the processor;
a camera communicatively coupled to the processor; and
a storage medium for tangibly storing thereon program logic for execution by the processor, the stored program logic comprising:
logic for monitoring, using the sensor, whether a user performs an action using the wearable device, the action causing a movement of the wearable device;
logic for determining, using the camera, that the user is visually focusing on a screen of the wearable device; and
logic for adjusting the screen when the logic for monitoring indicates that the user performs the action using the wearable device and the logic for determining indicates that the user is visually focusing on the screen of the wearable device.
